(19) United States
(12) Patent Application Publication
(10) Pub. No.: US 2004/0140152 A1
(43) Pub. Date: Jul. 22, 2004

(54) Convertible harness, and methods of use and manufacture

(76) Inventor: Hal Richardson, Gilbert, AZ (US)

Correspondence Address: Schwegman, Lundberg, Woessner & Kluth, P.A., P.O Box 2938, Minneapolis, MN, 55402, US

(21) Appl. No.: 10/699,594

(22) Filed: Oct. 30, 2003

Related U.S. Application Data
(60) Provisional application No. 60/422,347, filed on Oct. 31, 2002.

(51) Int. Cl. A62B 1/16

(52) U.S. Cl. 182/3

(57) ABSTRACT

A convertible harness includes a waist strap, shoulder straps, and a stowable pelvis enclosing assembly. In one embodiment, the pelvis enclosing assembly includes a pouch attached to the back of the harness, two leg loops, a crotch strap, and an attachment mechanism. A wearer releases the stowable pelvis enclosing assembly from the pouch, brings the crotch strap through his legs, attaches the attachment mechanism to an attachment point at the front of the harness, and tightens the strap. This converts the harness into a full body harness. The harness also includes a stowable rappelling assembly, in one embodiment, which includes a rappel assembly pouch, an anchor mechanism, a descender, a rappel line, and a harness attachment mechanism. The wearer pulls the anchor mechanism from the pouch, attaches the descender to an attachment point at the front of the harness, anchors the anchor mechanism, and rappels using the assembly.

### RELATED APPLICATION

This Application claims priority to U.S. Provisional Application No. 60/422,347 filed on Oct. 31, 2002 incorporated herein by reference.

### TECHNICAL FIELD

The present invention pertains to human body harnesses and, more particularly, to human body harnesses that are adapted to enable a wearer to rappel.

### BACKGROUND

Before entering a building in which a fire may be present, a firefighter normally puts on a harness, which holds a self-contained breathing apparatus (SCBA) system. The SCBA system includes a tank with compressed air, a regulator, a mask, valves, and tubing for delivering the air to the regulator and mask.

The standard SCBA harness is considered a “partial body” harness, as it includes only shoulder straps and a waist strap. More specifically, this type of harness is referred to as a “Class 1” harness (complete waist strap) with shoulder straps for the upper body. On the other hand, a “full body” harness includes shoulder, waist, and leg straps. A full body harness is also referred to as a “Class 3” harness, which encloses the waist, shoulders, and pelvis. Full body harnesses are used in certain rescue situations, but they are not typically worn by firefighters during a response to a normal fire situation, and they are not used in conjunction with current SCBA systems.

Some reasons that full body harnesses are not normally worn are that they are somewhat time-consuming and difficult to put on, they are relatively expensive, and they tend to restrict motion more than a partial body harness does. Besides these reasons, a partial body SCBA harness has been found to be sufficient to carry a SCBA system, and the additional leg straps included with a full body harness would not necessarily improve on the ability to carry the SCBA equipment.

Tragically, in the past, some firefighters have lost their lives after being rendered unconscious or becoming trapped while fighting a fire. If some of these firefighters had been wearing a full body harness, it might have been possible for them to be dragged from the fire or to have been rescued using external rappelling equipment. Because a partial body harness does not include leg straps, attempts to drag a firefighter or to rappel using such a harness would not likely succeed, because the harness would pull off of the firefighter's body when upward forces are applied to the harness. Accordingly, although a partial body harness is useful for carrying equipment, such a harness has relatively low value in a firefighter rescue situation.

Accordingly, what are needed are apparatus associated with a body harness, which are useful for rescuing an individual in an emergency situation. Further needed are rescue apparatus, which do not restrict motion more than the currently-used, partial body harnesses, while enabling an individual to be dragged or to rappel.

### BRIEF DESCRIPTION OF THE DRAWINGS

The appended claims point out different embodiments of the invention with particularity. However, the detailed description presents a more complete understanding of the present invention when considered in connection with the figures, wherein like-reference numbers refer to similar items throughout the figures and:

FIG. 1 is a perspective, back view of a partial body harness with a self-contained breathing apparatus (SCBA), in accordance with the prior art;

FIG. 2 is a perspective, back view of the partial body harness of FIG. 1 with the air tank removed;

FIG. 3 is a perspective, back view of a convertible body harness, which includes a stowed pelvis enclosing assembly, in accordance with an embodiment of the present invention;

FIG. 4 is a perspective, back view of a convertible body harness, after releasing the pelvis enclosing assembly from the pelvis assembly storage pouch, in accordance with an embodiment of the present invention;

FIG. 5 is a perspective, front view of a convertible body harness, with the pelvis assembly carabiner attached to an attachment point at the front of the harness, in accordance with an embodiment of the present invention;

FIG. 6 is a perspective, back view of a convertible body harness, which includes a stowed rappel line assembly, in accordance with an embodiment of the present invention;

FIG. 7 is a perspective view of the stowed rappel line assembly of FIG. 6, in accordance with an embodiment of the present invention;

FIG. 8 is a perspective view of the rappel line assembly of FIG. 7, after removing the rappel line assembly from the rappel line storage pouch, in accordance with an embodiment of the present invention;

FIG. 9 is a perspective, front view of a convertible body harness, with the descender attached to front of the harness, in accordance with an embodiment of the present invention;

FIG. 10 is a perspective, front view of a firefighter wearing a deployed, convertible body harness, in accordance with an embodiment of the present invention;

FIG. 11 is a flowchart of a procedure for using a convertible body harness, in accordance with an embodiment of the present invention;

FIG. 12 is a flowchart of a procedure for making a convertible body harness, in accordance with an embodiment of the present invention;

FIG. 13 is a flowchart of a procedure for assembling and attaching a pelvis enclosing assembly to the waist strap, thus forming a full body harness, in accordance with an embodiment of the present invention; and

FIG. 14 is a flowchart of a procedure for assembling and attaching a rappel line assembly to the body harness, in accordance with an embodiment of the present invention.

### DETAILED DESCRIPTION

Embodiments of the present invention provide apparatus associated with a body harness, which are useful for rescuing an individual in an emergency situation. The various embodiments include rescue apparatus, which do not restrict motion more than the currently-used, partial body harnesses, while enabling an individual to be dragged from an area or to rappel to safety.

In one embodiment, a convertible body harness includes shoulder straps, a waist strap, and a stowable pelvis enclosing assembly. The stowable pelvis enclosing assembly remains packed in a pelvis assembly pouch until the assembly is manually released. The pelvis assembly pouch is attached to the back of the harness. Upon release of the assembly, the wearer can manipulate the assembly in a manner that converts the partial body harness into a full body harness.

The term “back of the harness” refers to the portion of the harness in proximity to the wearer's back, after the harness has been donned. Conversely, the term “front of the harness” refers to the portion of the harness in proximity to the wearer's front, after the harness has been donned.

In another embodiment, a convertible body harness includes a stowable rappel line assembly. The stowable rappel line assembly remains packed in a rappel line assembly pouch, which is attached to the harness, until the assembly is manually released. At that time, the wearer can attach the assembly's descender to a waist attachment mechanism, anchor one end of the assembly's rappel line, and repel to safety.

In one embodiment, the stowable pelvis enclosing assembly and/or the stowable rappel line assembly are used in conjunction with an SCBA harness. In another embodiment, the stowable pelvis enclosing assembly and/or the stowable rappel line assembly are used in conjunction with some other type of partial body harness. In still another embodiment, the stowable rappel line assembly is used in conjunction with a full body harness.

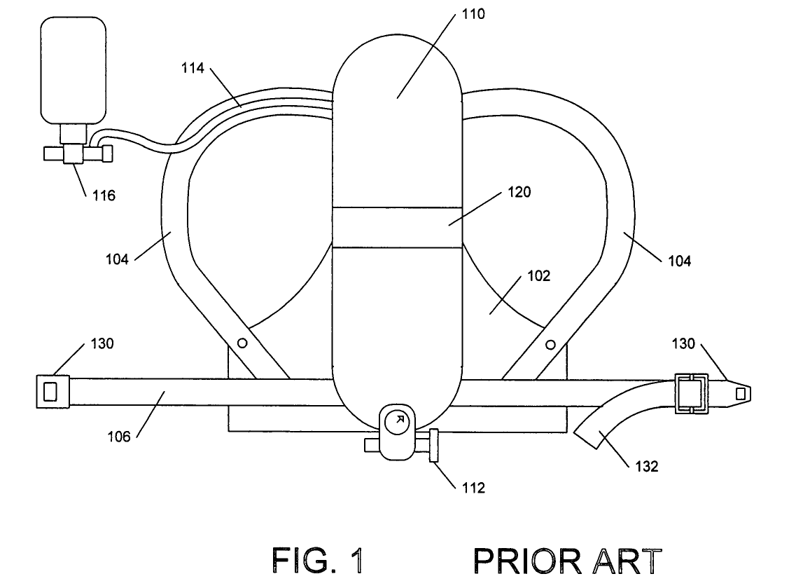

FIG. 1 is a perspective, back view of a partial body harness with a self-contained breathing apparatus (SCBA), in accordance with the prior art. The partial body harness includes a support member 102, two shoulder straps 104, and a waist strap 106. The SCBA system includes an air tank 110, a valve 112, tubing 114, a regulator 116, and a mask (not shown). The air tank 110 is secured to the harness using a band 120 and a mounting assembly (not shown).

In order to don the partial body harness of FIG. 1, a wearer slips his arms through the shoulder straps 104, and hoists the harness onto his back. The wearer then buckles a waist buckle 130 attached to the waist strap 106, and pulls an adjusting end 132 or “tail” of the waist strap 106 to tighten the strap around his waist. The wearer may also adjust the tightness of the shoulder straps 104 using adjustment mechanisms (not shown). After applying the regulator 116 and mask, and opening the valve 112, the wearer can then use the apparatus as a SCBA system.

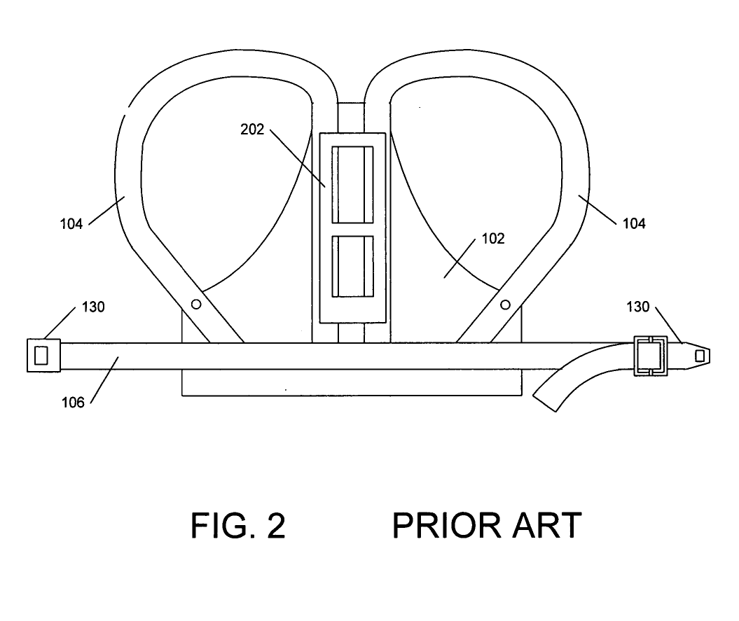

FIG. 2 is a perspective, back view of the partial body harness of FIG. 1 with the air tank removed. FIG. 2 illustrates the basic components of a partial body harness, which include the support member 102, two shoulder straps 104, waist strap 106, and waist buckle 130. The harness also includes a mounting assembly 202 and a band (e.g., band 120, FIG. 1), for supporting and securing the air tank (e.g., tank 110).

As mentioned previously, current SCBA harnesses are partial body harnesses. Accordingly, such harnesses do not include any members that enclose the pelvis (e.g., members that extend between the legs of the wearer from the front to the back). The lack of this pelvis-enclosing support makes current SCBA harnesses practically useless if the wearer must be dragged (e.g., by his shoulder straps) from an area, or the user must rappel from one floor to another to get below a fire, to the ground or off of a roof.

Embodiments of the invention enable a wearer to convert a partial body harness into a full body harness. Other embodiments enable a wearer to use a stowable rappel line assembly to rappel from one height to another.

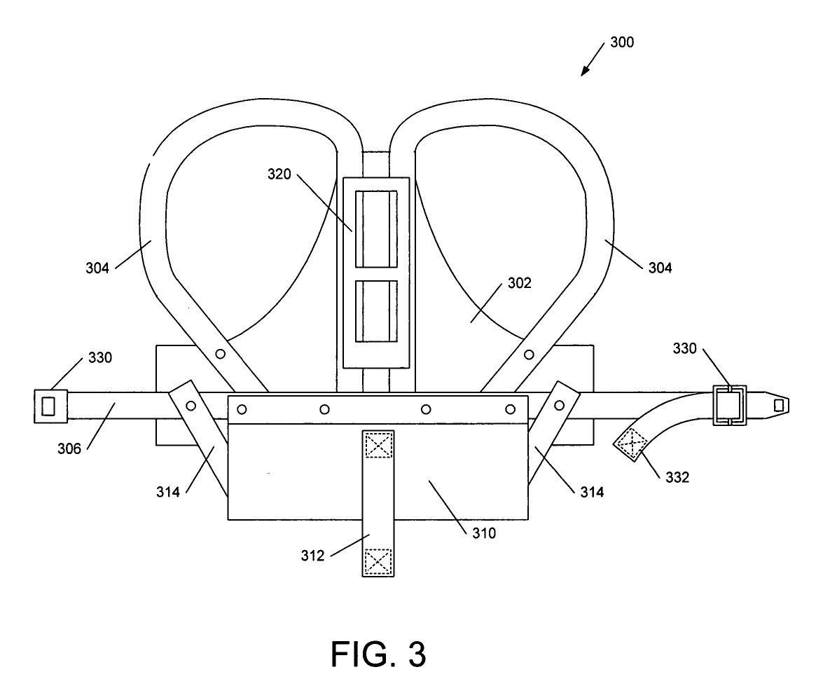

FIG. 3 is a perspective, back view of a convertible body harness, which includes a stowed pelvis enclosing assembly, in accordance with an embodiment of the present invention. Convertible harness 300 includes a support member 302, two shoulder straps 304, and a waist strap 306. Waist strap 306 is a continuous strap, in one embodiment. In other embodiments, waist strap 306 is non-continuous, meaning that it includes two or more separate straps.

In one embodiment, the convertible harness 300 is a SCBA harness, which also includes a SCBA system (e.g., air tank, valve, tubing, regulator, mask, etc.) and a mounting assembly 320 and band (not shown) for mounting and securing the SCBA system to the harness. In still other embodiments, convertible harness 300 is a type of harness other than a SCBA harness. For example, in other embodiments, harness 300 does not include a mounting assembly for a SCBA system, but instead is adapted to carry other types of items (e.g., a storage pouch and/or other gear and equipment).

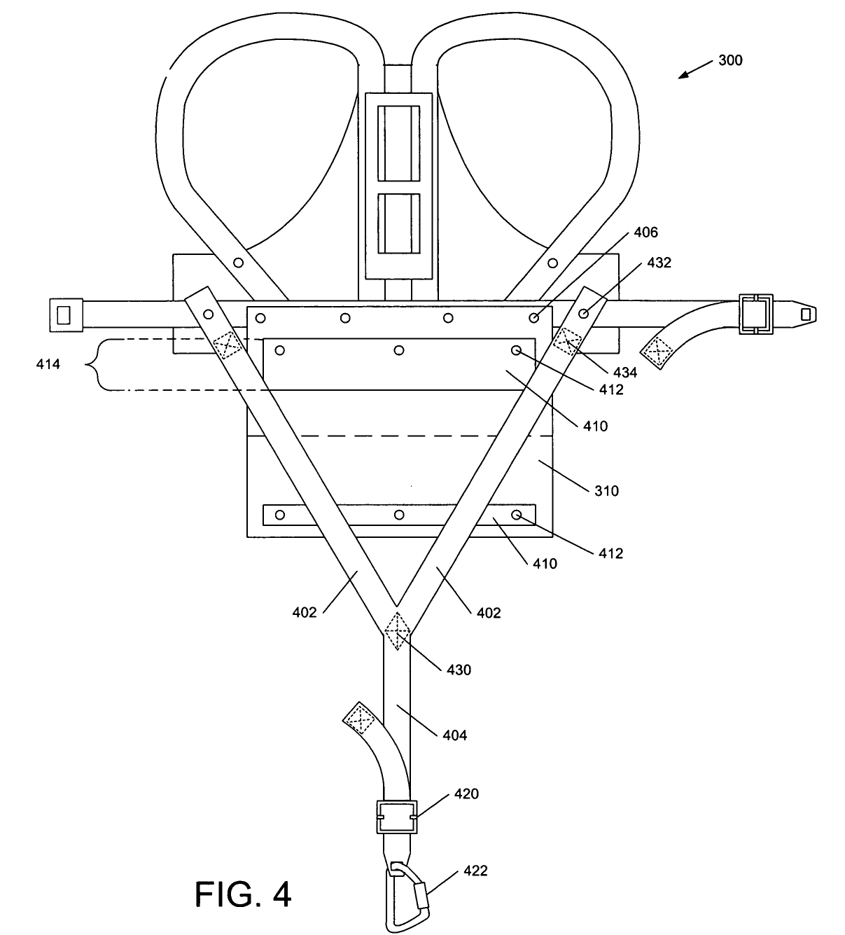

In one embodiment, convertible harness 300 includes a stowable pelvis enclosing assembly, which enables the convertible harness to be converted from a partial body harness (i.e., a harness with shoulder straps and a waist strap) to a full body, Class 3 harness (i.e., a harness with shoulder straps, a waist strap, and a strap assembly that attaches between the legs). The pelvis enclosing assembly includes a pouch 310 with a release mechanism 312, deployable straps 314, and an attachment mechanism (shown in FIG. 4, element 422).

The pelvis assembly pouch 310 is attached to the waist strap 306, in one embodiment. In the example of FIG. 4, pouch 310 is attached to the waist strap 306 using screws 406. In other embodiments, the pouch 310 is attached to the support member 302, one or more shoulder straps 304, or some other portion of the harness. In each of the various embodiments, pouch 310 is attached to the back of the harness.

In one embodiment, the pouch 310 is permanently attached to the back of the harness. For example, but not by way of limitation, the pouch 310 can be sewn, riveted, adhered, or otherwise attached to the harness (e.g., using grommets, pins, etc.). In another embodiment, the pouch 310 is removably attached to the back of the harness. For example, but not by way of limitation, the pouch 310 can be snapped or hooked to the harness, or attached using a hook-and-loop type fastener. In still another embodiment, a portion of the pouch could be looped over the waist strap and secured to another portion of the pouch.

FIG. 3 shows the pelvis enclosing assembly in an undeployed state, where the assembly is contained within the pouch 310, and the pouch 310 is folded upward and secured using a pouch closing mechanism (described later). The pouch 310 is opened using release mechanism 312. In one embodiment, the release mechanism 312 is a strap. When pulled, the release mechanism 312 enables the pelvis enclosing assembly to be deployed. In other embodiments, the release mechanism 312 could be a rope, a loop, a hook, or virtually any other mechanism that can be pulled to open the pouch 310.

The pelvis enclosing assembly is stowable, in one embodiment, meaning that it can be packed in the pouch 310 until needed. Accordingly, during operations that do not warrant the use of a full body harness, the pelvis enclosing assembly can remain packed away, so that the harness operates as a partial body harness.

The shoulder straps 304, waist strap 306, and deployable straps 314 have a thickness in a range of 1″-2″, in one embodiment, any or all of the straps could be wider or narrower, in other embodiments. Straps 304, 306, 314 are formed from an aramid fiber material (e.g., Kevlar, Nomex, etc.). Although the straps 304, 306, 314 are formed from the same material, in one embodiment, the straps 304, 306, 314 can be formed from different materials from each other, in other embodiments. The straps 304, 306, 314 are made from a heat and fire resistive material, in one embodiment. In other embodiments, the straps 304, 306, 314 are not heat or fire resistive.

In order to don the convertible harness of FIG. 3, a wearer slips his arms through the shoulder straps 304, and hoists the harness onto his back. The wearer then buckles a waist buckle 330 attached to the waist strap 306, and pulls an adjusting end 332 of the waist strap 306 to tighten the strap around his waist. The wearer may also adjust the tightness of the shoulder straps 304 using adjustment mechanisms (not shown). In an embodiment in which the harness 300 is used in conjunction with a SCBA system, the wearer can then use the attached SCBA system.

FIG. 4 is a perspective, back view of the convertible body harness 300 of FIG. 3, after releasing the deployable straps (i.e., straps 314, FIG. 3) from the pelvis assembly storage pouch 310, in accordance with an embodiment of the present invention. In one embodiment, the storage pouch 310 includes a pouch closing mechanism, which holds the pouch in a folded position, with the pelvis enclosing assembly packed inside, until the harness wearer (or another person) pulls the release mechanism (e.g., mechanism 312, FIG. 3) to disconnect the mechanism and open the pouch 310. At that time, the packed pelvis enclosing assembly is deployed by falling out of the pouch 310.

In one embodiment, the pouch closing mechanism includes a hook-and-loop type of fastener 410 (e.g., Velcro fastener). At least one side of the hook-and-loop fastener has a width 414, in one embodiment, chosen to reduce the likelihood that the pouch 310 will open at an unintended time. For example, in one embodiment, the width 414 of at least one side of the fastener is in a range of two or more inches. In addition, a wide fastener makes it easier for an individual to securely pack the pelvis enclosing assembly within the pouch 310.

In another embodiment, the pouch closing mechanism includes one or more snaps 412 (e.g., stainless steel, nylon, or plastic snaps). In still another embodiment, the pouch closing mechanism includes both snaps 412 and a hook-and-loop type fastener 410. In still other embodiments, the pouch closing mechanism includes buttons, hooks, and/or other detachable fastener mechanisms.

The deployable straps include two leg loops 402 and a crotch strap 404, in one embodiment. In addition, in one embodiment, the pelvis enclosing assembly includes a strap adjustment mechanism 420 and a crotch strap attachment mechanism 422. The strap adjustment mechanism 420 includes a buckle 420, in one embodiment, and the crotch strap attachment mechanism 422 includes a carabiner 422 (referred to as a “pelvis assembly carabiner”). In one embodiment, the pelvis assembly carabiner 422 is a locking carabiner.

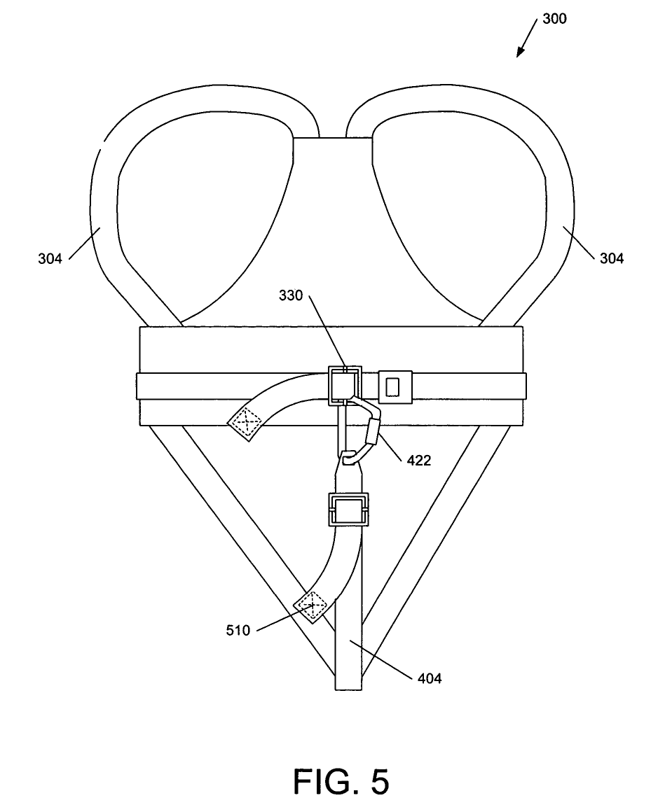

FIG. 5 is a perspective, front view of a convertible body harness, with the pelvis assembly carabiner 422 attached to an attachment point at the front of the harness, in accordance with an embodiment of the present invention. In one embodiment, the frontal attachment point is the waist buckle 330. In another embodiment, the frontal attachment point could be a loop, carabiner, hook, or some other mechanism to which the pelvis assembly carabiner 422 can be attached to the waist strap or buckle. FIG. 5 illustrates a harness after the wearer has brought the shoulder straps 304 over his shoulders, fastened the waist buckle 330, deployed the pelvis enclosing assembly, brought the crotch strap 404 between his legs, and clipped the pelvis assembly carabiner 422 to the waist buckle 330. The wearer can then pull the free end 510 of the crotch strap 404, in order to adjust the tightness of the pelvis enclosing assembly.

The leg loops 402 and crotch strap 404 illustrated in FIGS. 4 and 5 have roughly a “Y” shape, in one embodiment. In one embodiment, the leg loops 402 and crotch strap 404 are formed from two straps, where a first leg loop is formed from a first strap, and a second leg loop and the crotch strap 404 are formed from a second, longer strap. The first strap and the second strap are sewn or otherwise connected together at point 430 along the second strap. In one embodiment, the stitching includes a “box stitch” configuration (i.e., a rectangle with a corner-to-corner cross in the middle), which is formed from fire resistive thread (e.g., thread that includes Kevlar). In other embodiments, other stitching configurations could be used, or the thread could be made of a material that is not fire resistive. In other embodiments, a penetrating attachment mechanism (e.g., a screw, grommet, rivet, pin, etc.) is attached through the first and second straps. In other embodiments, the first and second straps can be otherwise sewn, riveted, adhered, or otherwise attached together. In still another embodiment, the “Y” shaped pelvis enclosing assembly is formed from more than two straps.

In one embodiment, the “Y” shaped pelvis enclosing assembly is attached at two points 432 (FIG. 4) to the back of the harness. As such, when the pelvis assembly carabiner 422 is attached to the waist buckle 330, the leg loops 402 and crotch strap 404 form a seat. In another embodiment, the pelvis enclosing assembly could simply include one crotch strap, which is attached at one point to the back of the harness, and is attachable at one point to the front of the harness. In still other embodiments, the pelvis enclosing assembly could be otherwise configured, and could attach at more than two points to the back of the harness and/or more than one point to the front of the harness.

The leg loops 402 are permanently attached to the waist strap 306 at the back of the harness, in one embodiment. In one embodiment, the end of each leg loop is looped over the waist strap 306, and sewn at points 430. In one embodiment, the stitching includes a box stitch configuration formed from fire resistive thread. In other embodiments, other stitching configurations could be used, or the thread could be made of a material that is not fire resistive. In order to further strengthen the attachment of the leg loops to the waist strap 306, in one embodiment, a penetrating attachment mechanism 432 (e.g., a screw, grommet, rivet, pin, etc.) is attached through the waist strap 306 and through both portions of the loop formed around the waist strap 306.

In other embodiments, the leg loops 402 can be otherwise sewn, riveted, adhered, or otherwise attached to the waist strap 306 and/or other portions of the harness. In still another embodiment, the leg loops 402 are removably attached to the waist strap 306 and/or other portions of the harness.

As illustrated in FIGS. 3-5, embodiments of the invention enable a partial body harness (i.e., a harness that includes only shoulder and waist straps) to be converted into a full body harness at the will of the wearer or another person. Such embodiments can be useful for several purposes, including lifesaving purposes. For example, as mentioned earlier, a firefighter responding to an emergency typically dons a SCBA harness, which includes the SCBA system. Because a firefighter does not normally require a full body harness, current SCBA harnesses are designed as partial body harnesses.

However, if a firefighter becomes injured or unconscious, it can be possible to save that firefighter's life, using embodiments of the present invention, by enabling that firefighter to be dragged from a hazardous environment. Current partial body harnesses are likely to pull off the firefighter if the firefighter is pulled by the harness' shoulder straps. Using embodiments of the invention, a partial body harness can be converted to a full body harness by the firefighter or by a rescuer (e.g., the firefighter's “buddy”, or another individual). The rescuer can then drag the firefighter using the shoulder straps, without pulling the harness off of the firefighter.

Besides enabling a partial body harness to be converted to a full body harness, various embodiments of the invention also enable a firefighter to rappel (or be rappelled) using a stowed rappel line assembly, which is used in conjunction with the full body harness.

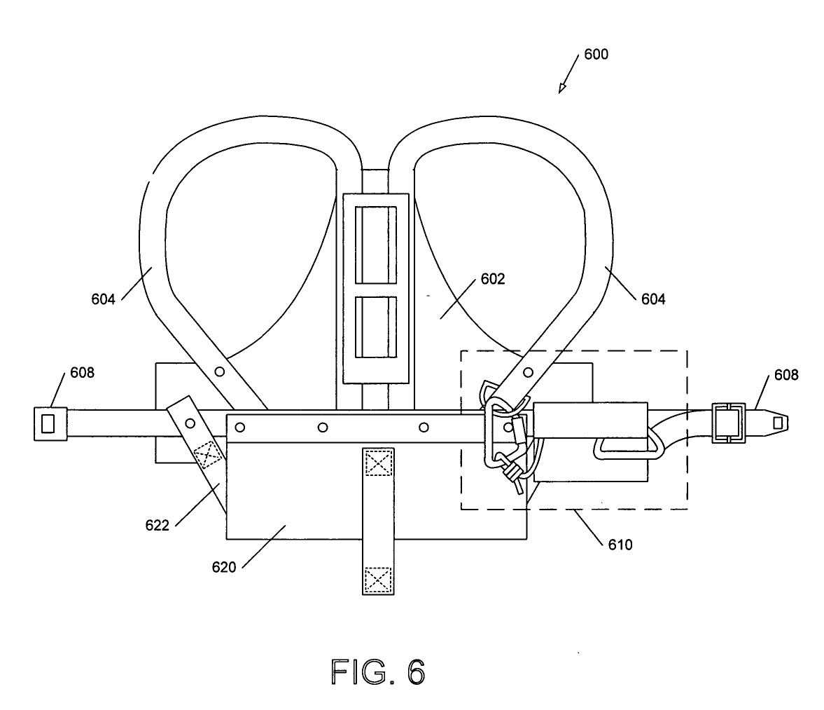

In one embodiment, the convertible harness includes a stowed rappel line assembly, which enables the harness to be used by the wearer to rappel from one height to another. FIG. 6 is a perspective, back view of a convertible body harness 600, which includes a stowed rappel line assembly 610, in accordance with an embodiment of the present invention. In one embodiment, the stowed rappel line assembly 610 is used in conjunction with a convertible harness, such as that illustrated and described in conjunction with FIGS. 3-5. Accordingly, the harness 600 includes a support member 602, two shoulder straps 604, a waist strap 606, a waist buckle 608, pelvis assembly storage pouch 620, and deployable straps 622. In another embodiment, the stowed rappel line assembly 610 is used in conjunction with a standard full body harness.

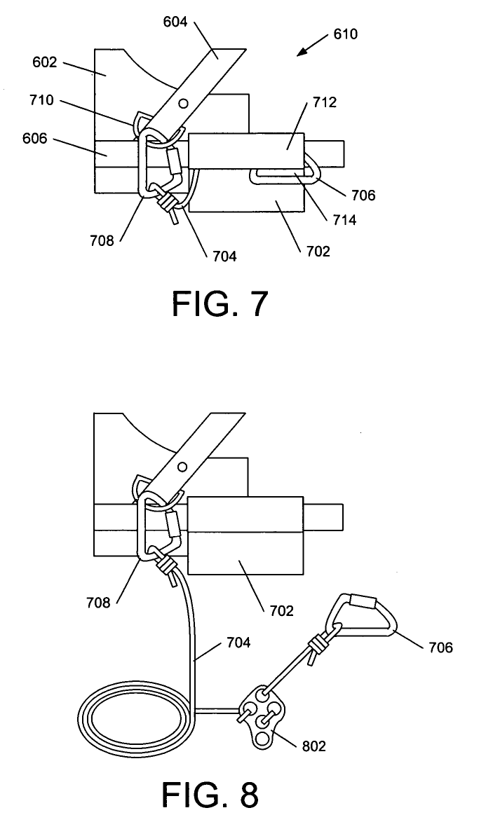

FIG. 7 is a perspective view of the stowed rappel line assembly 610 of FIG. 6, in accordance with an embodiment of the present invention. The rappel line assembly 610 enables a wearer to rappel from one height to another, using the assembly 610 and a converted full body harness, or a regular full body harness. In one embodiment, the rappel line assembly 610 includes a rappel line pouch 702, a rappel line 704, an anchor mechanism 706, a descender (shown in FIG. 8, element 802), and a harness attachment mechanism 708.

The rappel line pouch 702 is attached to the waist strap 606, in one embodiment. In other embodiments, the pouch 702 is attached to the support member 602, shoulder strap 604, or some other portion of the harness. In one embodiment, the rappel line pouch 702 is permanently attached to the harness. For example, but not by way of limitation, the pouch 702 can be sewn, riveted, adhered, or otherwise attached to the harness. In another embodiment, the pouch 702 is removably attached to the harness. For example, but not by way of limitation, the pouch 702 can be snapped or hooked to the harness, or attached using a hook-and-loop type fastener. In still another embodiment, a portion of the pouch 702 could be looped over the waist strap 606 and secured to another portion of the pouch.

The components of the rappel line assembly are assembled and attached to the harness to facilitate quick and easy use of the rappel line assembly, in various embodiments. In one such embodiment, one end of the rappel line 704 is pre-attached to the anchor mechanism 706, and the other end of the rappel line 704 is pre-attached to the harness attachment mechanism 708. In addition, the descender (shown in FIG. 8, element 802) is pre-wrapped, and the harness attachment mechanism 708 is attached to the harness, in one embodiment. In other embodiments, the descender is not pre-wrapped and/or the harness attachment mechanism 708 is not pre-attached.

In one embodiment, the harness attachment mechanism 708 is attached to a D-ring 710 affixed to a shoulder strap 604. In other embodiments, the harness attachment mechanism 708 is attached to a D-ring, loop or other mechanism affixed to another portion of the harness, or is attached directly to a portion of the harness (e.g., the support member 602, a shoulder strap 604 or the waist strap 606) without an intermediate ring, loop or other attachment mechanism. In still another alternate embodiment, one end of the rappel line 704 is attached to a ring (e.g., ring 710) or loop or directly attached to the harness, without the use of an intervening harness attachment mechanism.

The anchor mechanism 706 and harness attachment mechanism 708 are carabiners, in one embodiment. For example, the anchor and/or harness attachment mechanisms 706, 708 can be locking carabiners. In other embodiments, either or both mechanisms 706, 708 could be other types of attachment mechanisms.

In one embodiment, the rappel line assembly is packed and stowed in the pouch 702 in a manner that the anchor mechanism 706 is easily grasped. For example, as shown in FIG. 7, the anchor mechanism 706 is partially exposed from under a flap 712 of the pouch 702. The flap 712 is held closed, with respect to the rest of the pouch 702, using a pouch fastening mechanism. In various embodiments, this mechanism includes a hook-and-loop type fastener, one or more snaps or other removable attachment mechanisms. Accordingly, a portion of the pouch fastening mechanism connects the flap 712 to the rest of the pouch 702 through an opening 714 in the anchor mechanism 706. This holds the anchor mechanism 706 in place. When the anchor mechanism 706 is pulled, that portion of the pouch fastening mechanism releases, and the rappel line assembly is deployed.

FIG. 8 is a perspective view of the rappel line assembly of FIG. 7, after removing the rappel line assembly from the rappel line storage pouch (e.g., by pulling the anchor mechanism 706), in accordance with an embodiment of the present invention. As discussed above, the rappel line assembly includes a rappel line 704, anchor mechanism 706, descender 802, and harness attachment mechanism 708.

In one embodiment, rappel line 704 has a length that is sufficient to allow the user to rappel a significant distance. For example, but not by way of limitation, rappel line 704 can have a length in a range of 20 to 100 feet. In other embodiments, rappel line 704 can be longer or shorter.

Rappel line 704 is formed from a rope material that is sufficient to hold the weight of a human being. In one embodiment, rappel line 704 has a strength rating in a range of 4000-6000 lbs (pounds), although the rating could be larger or smaller, in other embodiments. In addition, in one embodiment, rappel line 704 has approximately a 16-to-1 safety factor (e.g., a 4000 lb. strength line for a 250 lb. person), although the safety factor could be larger or smaller, in other embodiments. Rappel line 704 has a thickness in a range of ¼″ to ¾″, in one embodiment, although line 704 could be thicker or thinner in other embodiments.

In addition, in one embodiment, rappel line 704 is formed from materials that include heat and fire resistive materials. For example, rappel line 704 includes an aramid fiber material (e.g., Kevlar). In one embodiment, rappel line 704 is further sheathed in a polyester material (e.g., Dacron). In other embodiments, rappel line 704 is formed from a material that is not heat or fire resistive. For example, line 704 could be formed from a material that includes nylon, which may or may not be fire and/or heat resistive.

In one embodiment, descender 802 is pre-wrapped on the rappel line 704in a position that is relatively close to anchor mechanism 706. For example, descender 802 is pre-wrapped in a range of 6″-18″ from the anchor mechanism 706, in one embodiment, although descender 802 could be closer to or farther from the anchor mechanism 706, in other embodiments.

Descender 802 is a pre-wrapped, hard descender (e.g., a FIG. 8 or otherwise configured descender), in one embodiment. In other embodiments, descender 802 could be a soft descender, a carabiner, or other mechanism that enables a person to descend, via friction, using the mechanism and a line. In other embodiments, descenders having configurations that are different from that illustrated in FIG. 8 could be used.

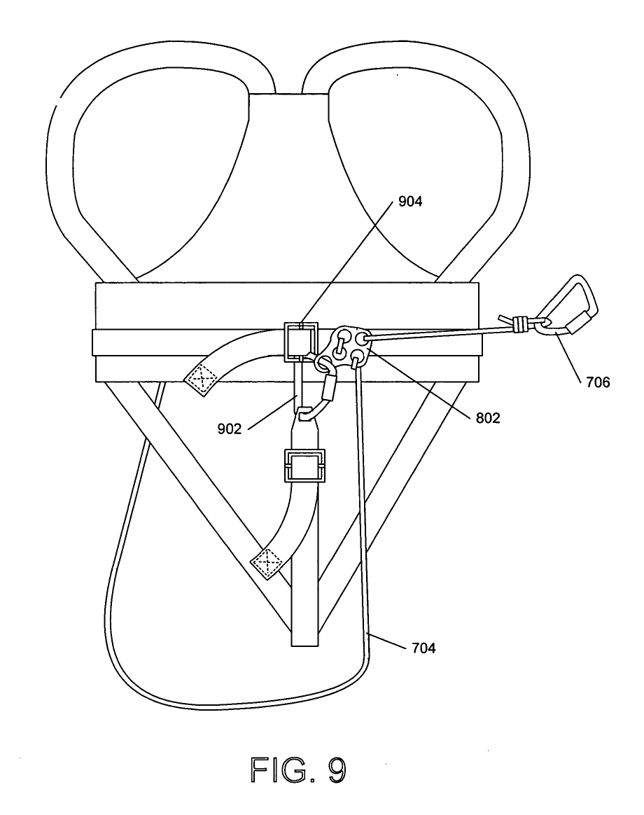

In order to use the rappel line assembly for the purpose of rappelling, descender 802 is attached to a front portion of the harness. FIG. 9 is a perspective, front view of a convertible body harness, with the descender 802 attached to the front of the harness, in accordance with an embodiment of the present invention. In one embodiment, descender 802 is attached to a crotch strap attachment mechanism 902 (e.g., mechanism 422, FIG. 4). In another embodiment, descender 802 is attached to waist buckle 904, or to another front harness attachment mechanism.

In order to rappel, the wearer attaches anchor mechanism 706 to a stable anchor. By allowing gravity to pull the wearer downward, and by controlling the rate of release of the rappel line 704 through descender 802, the wearer can safely rappel downward. Besides having application for rappelling, the line 704 can also be used for searching and orientation in poor visibility environments (e.g., in an environment of dense smoke and/or darkness) by attaching the line 704 to a hoseline or other object, and letting the line 704 deploy from the pouch 702 while searching. The line 704 can also be used to hoist hand tools, small hoselines, and other objects.

In one embodiment, rappel line assembly 610 is a “static” system, meaning that once the line 704 is completely extended, neither line 704 nor the other components allow for the system to be significantly stretched or otherwise lengthened. This means that, if the harness wearer does not maintain control of his or her descent, and falls, the wearer will receive the full shock of the fall, at the attachment point, when he or she reaches the end of the line. Accordingly, in one embodiment, the harness does not function as a fall arrest system.

In another embodiment, the rappel line assembly is converted to a “dynamic” system, by including one or more shock absorbing components (not shown) to the rappel line assembly. By including a shock absorbing component, the assembly is fully or partially converted into a fall arrest system. For example, in one embodiment, a shock absorbing component is included between the anchor mechanism (e.g., carabiner 706, FIG. 7) and the descender (e.g., descender 802, FIG. 8). Various shock absorbing components are known to those of skill in the art.

Besides enabling a firefighter to rappel himself or herself using the harness of the various embodiments, a rescuer can use the harness of the various embodiments to lower an unconscious or injured firefighter to safety. Accordingly, in one embodiment, after converting the harness to a full body harness, as described previously, a rescuer deploys and uses the rappel line assembly (e.g., assembly 610, FIG. 6) to lower the firefighter.

In one embodiment, the rescuer attaches the anchor mechanism (e.g., carabiner 706, FIGS. 7, 8) to an attachment point (not shown) on a portion of the harness, which is higher than the firefighter's center of gravity (e.g., higher than waist strap 606, FIG. 6). For example, attachment could be made to one or both shoulder straps (e.g., straps 604), or to another attachment point (e.g., a strap, loop, ring, etc.) that is higher than the waist strap. By making the attachment point higher than the firefighter's center of gravity, the firefighter is less likely to tip upside-down while being lowered.

Next, the rescuer anchors the harness attachment mechanism (e.g., carabiner 708, FIGS. 7, 8) to a solid object, and attaches the descender (e.g., descender 802) to the harness attachment mechanism. To anchor the harness attachment mechanism, the mechanism itself can be attached (e.g., clipped) to the solid object, or the line adjacent to the mechanism can be looped around and/or tied to the object, and the mechanism can be attached (e.g., clipped or tied) to the line. The rescuer then allows the firefighter to descend, while controlling the rate of descent from the anchor point.

As the above paragraphs indicate, embodiments of the invention can be used to save lives. In addition, embodiments of the invention can be used in other ways to facilitate the efforts of firefighters and other individuals in performing their jobs and achieving their goals.

The convertible harness of the various embodiments can be used for other purposes, as well. For example, the convertible harness could form a portion of a backpack, and could be used by a hiker or other individual to convert the backpack into a full body harness.

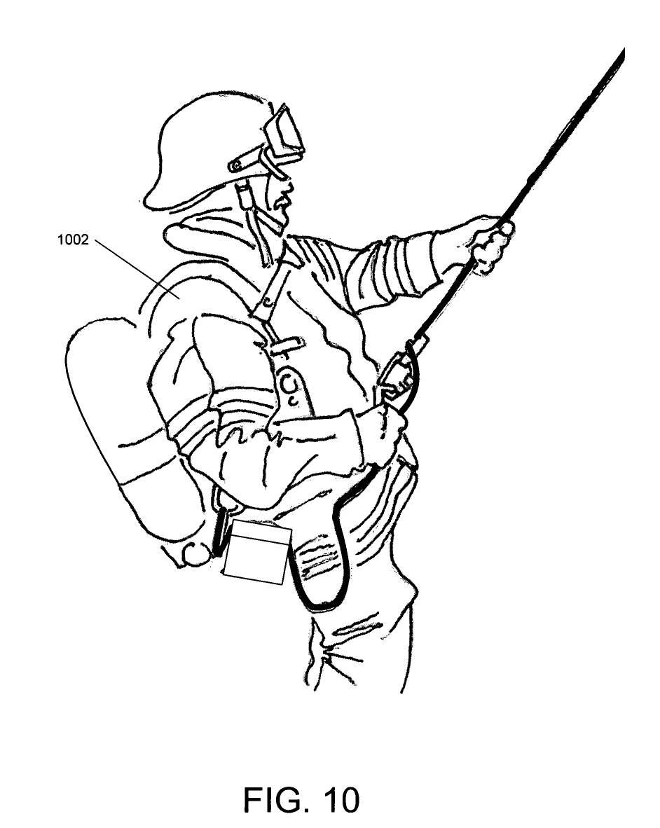

FIG. 10 is a perspective, front view of a firefighter 1002 wearing a deployed, convertible body harness, in accordance with an embodiment of the present invention. Using the harness and the rappelling equipment of the various embodiments, a firefighter 1002 who is trapped above a burning level of a building can rappel below the fire to a safer level or to the ground. Accordingly, embodiments of the invention can be used as a lifesaving device for a firefighter or other person. Alternatively, a firefighter can use a harness according to the various embodiments to rappel to an area where otherwise unreachable victims are present.

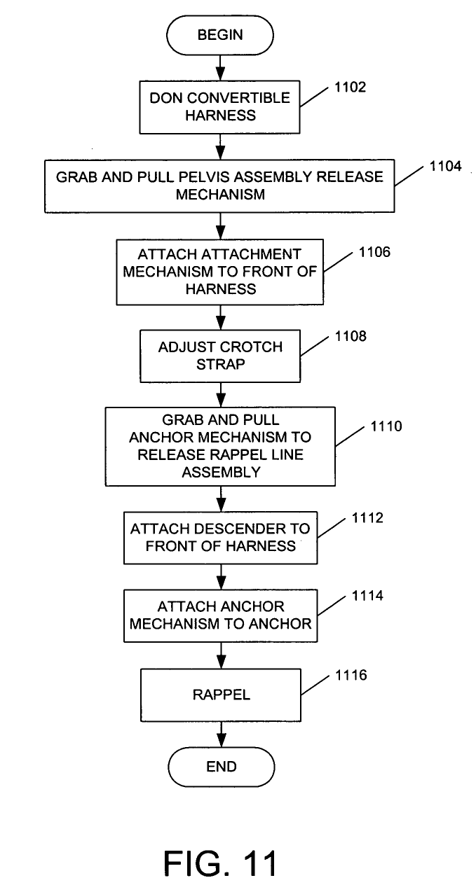

FIG. 11 is a flowchart of a procedure for using a convertible body harness, in accordance with an embodiment of the present invention. The method begins, in block 1102, by a wearer donning a convertible harness according to the various embodiments. As described earlier, this involves the wearer slipping his arms through the shoulder straps (e.g., straps 304, FIG. 3), and hoisting the harness onto his back. The wearer then buckles a waist buckle (e.g., buckle 330) attached to the waist strap (e.g., strap 306), and pulls an adjusting end (e.g., end 332) of the waist strap to tighten the strap around his waist. The wearer may also adjust the tightness of the shoulder straps using adjustment mechanisms.

When the wearer wishes to convert the partial body harness into a full body harness, the wearer grabs and pulls the leg loop release mechanism (e.g., strap 312, FIG. 3), in block 1104. This causes the pelvis enclosing assembly to deploy (e.g., as in FIG. 4).

In block 1106, the wearer pulls the crotch strap (e.g., strap 404, FIG. 4) through his legs, and attaches the crotch strap attachment mechanism (e.g., carabiner 422) to the front of the harness (e.g., to waist buckle 330), as illustrated in FIG. 5. The wearer can adjust the length of the crotch strap, in block 1108, by pulling the free end (e.g., end 510, FIG. 5). At this point, the formerly partial body harness is now a full body harness.

If the wearer wishes to deploy the stowed rappelling equipment, the user grabs and pulls the anchor mechanism (e.g., carabiner 706, FIG. 7), in block 1110. This releases the anchor mechanism, the descender (e.g., descender 802, FIG. 8), and the rappel line (e.g., line 704, FIG. 8). In block 1112, the wearer attaches the descender to the front of the harness, as illustrated in FIG. 9. In one embodiment, the wearer attaches the descender to the crotch strap attachment mechanism (e.g., carabiner 902, FIG. 9). In other embodiments, the wearer attaches the descender elsewhere to the front of the harness.

In block 1114, the wearer then attaches the anchor mechanism (e.g., carabiner 706, FIG. 9) to or around an anchor. For example, a suitable anchor could be a pillar, a heavy piece of furniture, a tree, a rock, or another object capable of holding the weight of the wearer. Once the rappelling equipment is anchored, the wearer can rappel to a lower level by allowing gravity to pull him downward, while controlling the release of the rappel line through the descender. The method then ends.

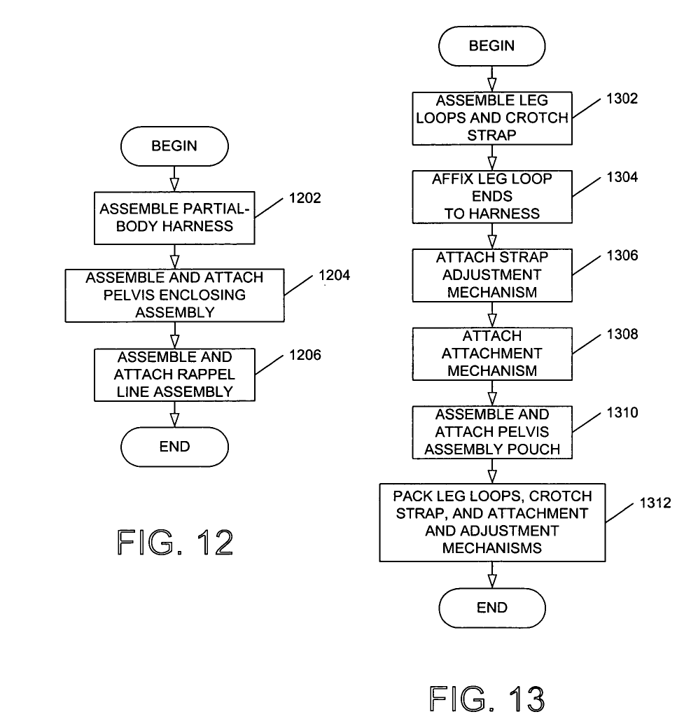

FIG. 12 is a flowchart of a procedure for making a convertible body harness, in accordance with an embodiment of the present invention. The method begins, in block 1202, by assembling a partial body harness. For example, as described above, a partial body harness includes a waist strap (e.g., strap 306, FIG. 3) and two shoulder straps (e.g., straps 304). In addition, the harness may include a support member (e.g., member 302), although the member can be excluded in some embodiments.

In block 1204, a stowable pelvis enclosing assembly is assembled and attached to the harness. As described above, a stowable pelvis enclosing assembly can include a pouch (e.g., pouch 310), a release mechanism (e.g., strap 312), leg straps (e.g., straps 402, FIG. 4), a crotch strap (e.g., strap 404), an adjustment mechanism (e.g., buckle 420), and an attachment mechanism (e.g., carabiner 422). A method for assembling and attaching a stowable pelvis enclosing assembly is described in more detail, below, in conjunction with FIG. 13.

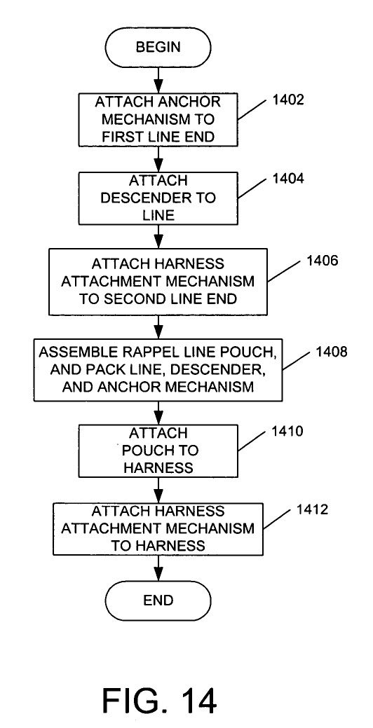

In block 1206, a stowable rappel line assembly is assembled and attached to the harness. As described above, a stowable rappel line assembly can include a pouch (e.g., pouch 702, FIG. 8), harness attachment mechanism (e.g., carabiner 708), rappel line (e.g., line 704), descender (e.g., descender 802), and anchor attachment mechanism (e.g., carabiner 706). A method for assembling and attaching a stowable rappelling assembly is described in more detail, below, in conjunction with FIG. 14. The method of FIG. 12 then ends.

FIG. 13 is a flowchart of a procedure for assembling and attaching a pelvis enclosing assembly to the waist strap, thus forming a full body harness, in accordance with an embodiment of the present invention. For example, the method of FIG. 13 could be performed in conjunction with block 1204 (FIG. 12).

The method begins, in block 1302, by assembling leg loops (e.g., straps 402, FIG. 4) and a crotch strap (e.g., strap 404). In one embodiment, two or more straps are permanently attached together (e.g., by stitching, rivet or adhesive) to form a “Y” shaped strap assembly. In other embodiments, the “leg loops” could be a single strap, or a strap assembly having other than a “Y” shape could be assembled.

In block 1304, the ends of the leg loops (e.g., loops 402) are affixed to the back of the harness. In one embodiment, the ends are permanently attached to the harness waist strap (e.g., strap 306, FIG. 3). In other embodiments, the ends are attached to the support member (e.g., member 302), the shoulder straps (e.g., straps 304), or to some other part of the harness.

In block 1306, the crotch strap adjustment mechanism (e.g., buckle 420, FIG. 4) is attached to the crotch strap. In one embodiment, the crotch strap is threaded through the adjustment mechanism, in order to hold an adjusted strap in place by force of friction.

In block 1308, an attachment mechanism (e.g., carabiner 422, FIG. 4) is attached to the adjustment mechanism, or to a portion of the crotch strap that extends beyond the adjustment mechanism.

In block 1310, the pelvis assembly pouch (e.g., pouch 310, FIG. 3) is assembled and attached to the harness. In one embodiment, the pouch is permanently attached, as described above. In another embodiment, the pouch is removably attached.

In block 1312, the leg loops, crotch strap, attachment mechanism, and adjustment mechanism are rolled or folded, and packed within the pouch, as illustrated in FIG. 3. The pouch attachment mechanism (e.g., hook-and-loop fastener 410, FIG. 4) is closed, and the method ends.

FIG. 14 is a flowchart of a procedure for assembling and attaching a rappel line assembly to the body harness, in accordance with an embodiment of the present invention. For example, the method of FIG. 14 could be performed in conjunction with block 1206 (FIG. 12).

The method begins, in block 1402, by attaching the anchor mechanism (e.g., carabiner 706, FIG. 8) to a first end of a rappel line (e.g., line 704). In one embodiment, attachment is made by forming a secure knot around a portion of the anchor mechanism. In other embodiments, the line could be crimped, riveted, or otherwise attached to the anchor mechanism.

In block 1404, the descender (e.g., descender 802) is attached to the rappel line. In one embodiment, attachment is made by wrapping the line through the descender so that the line is ready to be fed through the descender, when needed.

In block 1406, the harness attachment mechanism (e.g., carabiner 708, FIG. 8) is attached to a second end of the rappel line (e.g., line 704). In one embodiment, attachment is made by forming a secure knot around a portion of the attachment mechanism. In other embodiments, the line could be crimped, riveted, or otherwise attached to the attachment mechanism.

In block 1408, the rappel assembly pouch is assembled, and the rappel line, descender, and anchor mechanism are packed into the rappel assembly pouch (e.g. pouch 702, FIG. 7). In one embodiment, as described previously, a portion of the anchor mechanism is left exposed, to facilitate pulling the anchor mechanism, descender, and rappel line from the pouch, when needed.

In block 1410, the pouch is attached to the harness. In one embodiment, the pouch is permanently attached, as described above. In another embodiment, the pouch is removably attached.

In block 1412, the harness attachment mechanism (e.g., carabiner 708, FIG. 8) is attached to the harness. In one embodiment, the mechanism is attached to a loop (e.g., loop 710, FIG. 10) on the harness. In other embodiments, the mechanism is attached using another type of attachment, or the mechanism is attached directly to the harness without the use of an intervening attachment. The method then ends.

The order of the functional blocks presented in FIGS. 12-14 can be altered without departing from the spirit and scope of the invention. In addition, some of the functions can be performed in parallel with other functions. Therefore, the particular arrangement of the functional blocks should not be construed as limiting the invention to the illustrated order.

Thus, various embodiments of a method, apparatus, and system have been described which enable a partial body harness to be selectively converted to a full body harness, which also includes stowable rappelling equipment. The foregoing description of specific embodiments reveals the general nature of the invention sufficiently that others can, by applying current knowledge, readily modify and/or adapt it for various applications without departing from the generic concept. Therefore such adaptations and modifications are within the meaning and range of equivalents of the disclosed embodiments.

For example, although embodiments of the invention have been described in the context of a partial body harness, and more specifically, a SCBA harness often worn by firefighters, embodiments of the invention could also be used with non-SCBA harnesses, with backpacks, and with other similar apparatus. In addition, embodiments of the invention are not meant to be limited to use by firefighters in conjunction with SCBA equipment. Harnesses and backpacks adapted for climbing, hiking, and supporting self contained underwater breathing apparatus (SCUBA) gear also could use embodiments of the invention and obvious adaptations.

An embodiment of the invention includes a body harness that includes a stowable pelvis enclosing assembly. Another embodiment of the invention includes a body harness that includes a stowable rappelling assembly. In other embodiments, the stowable pelvis enclosing assembly and/or the stowable rappelling assembly are provided as kits, which are used to convert a partial body harness. In other words, a first body harness kit includes a stowable pelvis enclosing assembly adapted to be connected to a partial body harness to convert that partial body harness into a convertible body harness. A second body harness kit includes a stowable rappelling assembly. The stowable rappelling assembly is adapted to be connected to a partial body harness or a full body harness to convert the harness into a harness that can be used by the wearer or another person to rappel the wearer. In still another embodiment, a kit includes a stowable pelvis enclosing assembly and a stowable rappelling assembly.

The phraseology or terminology employed herein is for the purpose of description and not of limitation. Accordingly, the invention embraces all such alternatives, modifications, equivalents and variations as fall within the spirit and broad scope of the appended claims.

What is claimed is:

1. A self contained breathing apparatus (SCBA) harness comprising:
a mounting assembly, adapted to mount a SCBA air tank to the harness;
a waist strap, adapted to enclose a waist of a wearer of the harness, wherein the waist strap includes a frontal attachment point at a front of the harness;
two shoulder straps, adapted to enclose shoulders of the wearer; and
a stowable pelvis enclosing assembly, adapted to enclose a pelvis of the wearer, wherein the stowable pelvis enclosing assembly includes
at least one deployable strap,
an attachment mechanism adapted to connect the at least one deployable strap to the frontal attachment point, and
a pelvis assembly pouch, adapted to contain the at least one deployable strap and the attachment mechanism in a stowed state.

2. The harness of claim 1, wherein the at least one deployable strap comprises:
a crotch strap; and
two leg loops, wherein the two leg loops and the crotch strap form a Y shape, and wherein first ends of the leg loops are adapted to attach to the waist strap.

3. The harness of claim 1, further comprising:
a stowable rappel line assembly, which includes
a rappel line having a first end and a second end,
a harness attachment mechanism, attached to the first end, wherein the harness attachment mechanism is adapted to attach to a harness attachment point on the harness,
an anchor mechanism, attached to the second end, wherein the anchor mechanism is adapted to provide an anchor for the stowable rappel line assembly,
a descender, adapted to attach to the rappel line; and
a rappel line pouch, adapted to contain the rappel line, the descender, and the anchor mechanism.

4. The harness of claim 3, wherein the descender is pre-wrapped with the rappel line prior to stowing the descender and rappel line in the rappel line pouch.

5. A harness comprising:
a waist strap, adapted to enclose a waist of a wearer of the harness, wherein the waist strap includes a frontal attachment point at a front of the harness;
two shoulder straps, adapted to enclose shoulders of the wearer; and
a stowable pelvis enclosing assembly, adapted to enclose a pelvis of the wearer, wherein the stowable pelvis enclosing assembly includes
at least one deployable strap,
an attachment mechanism adapted to connect the at least one deployable strap to the frontal attachment point, and
a pelvis assembly pouch, adapted to contain the at least one deployable strap and the attachment mechanism in a stowed state.

6. The harness of claim 5, wherein the at least one deployable strap comprises:
a crotch strap; and
two leg loops, wherein the two leg loops and the crotch strap form a Y shape, and wherein first ends of the leg loops are adapted to attach to the waist strap.

7. The harness of claim 6, wherein a first leg loop and the crotch strap are formed from a first strap, and a second leg loop is formed from a second strap, which is connected to the first strap.

8. The harness of claim 5, further comprising:
an adjustment mechanism, adapted to adjust a length of the at least one deployable strap.

9. The harness of claim 5, wherein the at least one deployable strap and the pelvis assembly pouch are formed from fire resistive materials.

10. The harness of claim 5, further comprising:
a stowable rappel line assembly, adapted to attach to the waist strap, wherein the stowable rappel line assembly includes
a rappel line having a first end and a second end,
a harness attachment mechanism, attached to the first end, wherein the harness attachment mechanism is further adapted to attach to a harness attachment point on the harness,
an anchor mechanism, attached to the second end, wherein the anchor mechanism is adapted to provide an anchor for the stowable rappel line assembly,
a descender, adapted to attach to the rappel line; and
a rappel line pouch, adapted to contain the rappel line, the descender, and the anchor mechanism.

11. The harness of claim 10, wherein the descender is pre-wrapped with the rappel line prior to stowing the descender and rappel line in the rappel line pouch.

12. The harness of claim 10, wherein the rappel line and the rappel line pouch are formed from fire resistive materials.

13. A harness comprising:
a waist strap, adapted to enclose a waist of a wearer of the harness;
two shoulder straps, adapted to enclose shoulders of the wearer; and
a stowable rappel line assembly, adapted to attach to the waist strap, wherein the stowable rappel line assembly includes
a rappel line having a first end and a second end,
a harness attachment mechanism, attached to the first end, wherein the harness attachment mechanism is further adapted to attach to a harness attachment point on the harness,
an anchor mechanism, attached to the second end, wherein the anchor mechanism is adapted to provide an anchor for the stowable rappelling assembly,
a descender, adapted to attach to the rappel line; and
a rappel line pouch, adapted to contain the rappel line, the descender, and the anchor mechanism.

14. The harness of claim 13, wherein the waist strap includes a frontal attachment point at a front of the harness, the harness further comprising:
a stowable pelvis enclosing assembly, adapted to enclose a pelvis of the wearer, wherein the stowable pelvis enclosing assembly includes
at least one deployable strap,
an attachment mechanism adapted to connect the at least one deployable strap to the frontal attachment point, and
a pelvis assembly pouch, adapted to contain the at least one deployable strap and the attachment mechanism in a stowed state.

15. The body harness of claim 14, wherein the at least one deployable strap comprises:
a crotch strap; and
two leg loops, wherein the two leg loops and the crotch strap form a Y shape, and wherein first ends of the leg loops are adapted to attach to the waist strap.

16. A kit comprising:
a stowable pelvis enclosing assembly, adapted to enclose a pelvis of a wearer of a harness that includes a waist strap and two shoulder straps, wherein the stowable pelvis enclosing assembly includes
at least one deployable strap,
an attachment mechanism adapted to connect the at least one deployable strap to a frontal attachment point of the harness, and
a pelvis assembly pouch, adapted to contain the at least one deployable strap and the attachment mechanism in a stowed state; and
a stowable rappel line assembly, which includes
a rappel line having a first end and a second end,
a harness attachment mechanism, attached to the first end, wherein the harness attachment mechanism is further adapted to attach to a harness attachment point on the harness,
an anchor mechanism, attached to the second end, wherein the anchor mechanism is adapted to provide an anchor for the stowable rappelling assembly,
a descender, adapted to attach to the rappel line; and
a rappel line pouch, adapted to contain the rappel line, the descender, and the anchor mechanism.

17. The kit of claim 16, wherein the at least one deployable strap comprises:
a crotch strap; and
two leg loops, wherein the two leg loops and the crotch strap form a Y shape, and wherein first ends of the leg loops are adapted to attach to the waist strap.

18. The kit of claim 16, wherein the at least one deployable strap, the pelvis assembly pouch, the rappel line, and the rappel line pouch are formed from fire resistive materials.

19. A method for making a kit for a partial body harness, the method comprising:
assembling a stowable pelvis enclosing assembly adapted to be connected to the partial body harness, wherein assembling the stowable pelvis enclosing assembly includes
assembling two leg loops and a crotch strap, wherein first ends of the two leg loops are adapted to attach to a waist strap of the partial body harness;
attaching an attachment mechanism to the crotch strap, wherein the attachment mechanism is adapted to attach to a frontal attachment point at a front of the partial body harness; and
assembling a pelvis assembly pouch, wherein the pelvis assembly pouch is adapted to contain the two leg loops, the crotch strap, and the attachment mechanism in a stowed state, and wherein the pelvis assembly pouch is further adapted to attach to the waist strap.

20. The method of claim 19, further comprising:
assembling a stowable rappel line assembly adapted to be connected to the partial body harness, wherein assembling the stowable rappel line assembly includes
attaching an anchor mechanism to a first end of a rappel line;
wrapping a descender with the rappel line;
attaching a harness attachment mechanism to a second end of the rappel line; and
assembling a rappel line pouch, wherein the rappel line pouch is adapted to contain the rappel line, the anchor mechanism, and the descender, and wherein the rappel line pouch is further adapted to attach to the waist strap.
